(19) United States
(12) Patent Application Publication
(10) Pub. No.: US 2021/0129454 A1
(43) Pub. Date: May 6, 2021

(54) HYBRID TUBE AND MANUFACTURING METHOD THEREFOR

(71) Applicant: SHPAC CO., LTD, Busan (KR)

(72) Inventors: Yun Ju LEE, Yongin-Si (KR); Hye Kyeong LEE, Changwon-Si (KR); Tae Ho HWANG, Busan (KR); Yeon Jung JANG, Tongyeong-Si (KR)

(73) Assignee: SHPAC CO., LTD

(21) Appl. No.: 17/147,635

(22) Filed: Jan. 13, 2021

Related U.S. Application Data
(63) Continuation of application No. PCT/KR2018/008780, filed on Aug. 2, 2018.

(30) Foreign Application Priority Data
Jul. 31, 2018 (KR) 10-2018-0089547

(51) Int. Cl. B29C 70/02; B32B 15/04

(52) U.S. Cl. CPC B29C 70/028; F02F 1/004; B32B 15/04

(57) ABSTRACT

Proposed is manufacturing method for a hybrid tube, the method including the step of deriving an optimal ratio between a metal tube and a composite material layer when manufacturing the hybrid tube in which the composite material layer is formed on an outer circumferential surface of the metal tube in order to reduce the weight of an existing metal tube such as a cylinder tube of a hydraulic cylinder. In manufacturing a hybrid tube, it is possible to derive an optimal ratio between heterogeneous materials that can achieve weight reduction while satisfying a target buckling load, thereby making it possible to reduce the weight of tubes of metal materials and apparatuses related to such tubes.

### REFERENCE TO RELATED APPLICATIONS

This is a continuation of International Patent Application PCT/KR2018/008780 filed on Aug. 2, 2018, which designates the United States and claims priority of Korean Patent Application No. 10-2018-0089547 filed on Jul. 31, 2018, the entire contents of which are incorporated herein by reference.

### FIELD OF THE INVENTION

The present disclosure relates to a hybrid tube and a manufacturing method therefor. More particularly, the present disclosure relates to a manufacturing method for a hybrid tube, the method including the step of deriving an optimal ratio between a metal tube and a composite material layer when manufacturing the hybrid tube in which the composite material layer is formed on an outer circumferential surface of the metal tube in order to reduce the weight of an existing tube such as a cylinder tube.

### BACKGROUND OF THE INVENTION

A hydraulic cylinder is a core component of construction equipment and high place operation cars, and the need to develop a lightweight hydraulic cylinder has recently arisen.

If the weight of the hydraulic cylinder is reduced by 30%, the total weight of construction equipment and high place operation cars can be reduced by 6 to 15%, which can improve energy efficiency in equipment operation, and thus the development of lightweight hydraulic cylinders is attracting attention.

In order to reduce the weight of such hydraulic cylinders, a cylinder tube and a rod are each entirely or partially made of carbon fiber reinforced plastic (CFRP), which is a high-tech plastic composite material that is attracting attention as a high-strength, high-elasticity, and lightweight structural material.

In particular, in the case of a tubular cylinder tube, a composite material layer is formed on an outer circumferential surface of the tube using a filament winding technique, so that the tube is manufactured as a hybrid tube in which a metal material and CFRP are mixed, thereby realizing weight reduction.

However, in order to achieve weight reduction while satisfying a target buckling load in manufacturing the hybrid tube, it is necessary to calculate an appropriate ratio between metal and CFRP, but research and development on a method of calculating such a ratio is insufficient.

Therefore, there is a need to develop a technology capable of presenting an optimal ratio between heterogeneous materials of a hybrid tube so as to contribute to the development of a lightweight hydraulic cylinder.

Korean Patent No. 10-1041448, entitled “Transfer shaft and method of manufacturing the same” (Registration date: Jun. 8, 2011)

### SUMMARY OF THE INVENTION

Accordingly, the present disclosure has been made keeping in mind the above problems occurring in the related art, and an objective of the present disclosure is to provide a manufacturing method for a hybrid tube, the method including the step of deriving an optimal ratio between a metal tube and a composite material layer when manufacturing the hybrid tube in which the composite material layer is formed on an outer circumferential surface of the metal tube in order to reduce the weight of an existing metal tube such as a cylinder tube of a hydraulic cylinder.

The above and other objectives and advantages of the present disclosure will be understood from the following description. In addition, it is understood that the objectives and advantages of the present disclosure will be encompassed widely in the scope of the present disclosure by not only the descriptions in the appended claims and the embodiments of the present disclosure, but also means within the scope of the present disclosure that can be easily inferred therefrom and their combinations.

According to an aspect of the present disclosure to accomplish the above objective, there is provided a method of manufacturing a hybrid tube including a metal tube and a composite material layer formed on an outer circumferential surface of the metal tube for weight reduction, the method including the steps of: (a) setting a first outer diameter OD1, a length L, a set buckling load F, an end condition factor n, and a first safety factor SF1 of the hybrid tube, and setting a material and a modulus of elasticity E of the metal tube; (b) selecting a population for a thickness value of the metal tube in a range equal to or less than the first outer diameter OD1, and calculating a slenderness ratio using the selected population and the length L to determine a method for calculating a critical buckling load PC of the population; (c) calculating the critical buckling load PC and a second safety factor SF2 of the metal tube for the population by the determined method, and calculating a third safety factor SF3 of the metal tube closest to the first safety factor SF1 among the respective calculated second safety factors SF2; and (d) deriving an optimal ratio between the metal tube and the composite material layer for weight reduction by using a thickness that can reduce the weight of the hybrid tube among thickness values of the metal tube in the population, the thickness values corresponding to the third safety factor SF3.

In addition, according to a preferred embodiment of the present disclosure, the population for the thickness value of the metal tube may be formed by selecting any one of values of a second outer diameter OD2 in a range equal to or less than the first outer diameter OD1 as a value of a metal outer diameter ODm, selecting values within a range equal to or less than the selected value of the metal outer diameter ODm as values of a metal inner diameter IDm, selecting a plurality of values of the metal outer diameter ODm, and selecting values of the metal inner diameter IDm for each of the selected plurality of values of the metal outer diameter ODm.

In addition, according to a preferred embodiment of the present disclosure, the method for calculating the critical buckling load PC of the metal tube in the step (b) may use either Rankine's method or Euler's method according to the calculated slenderness ratio.

According to another aspect of the present disclosure to accomplish the above objective, there is provided a method of manufacturing a hybrid tube including a metal tube and a composite material layer formed on an outer circumferential surface of the metal tube for weight reduction, the method including the steps of: (a) setting a first outer diameter OD1, a length L, a set buckling load F, an end condition factor n, and a first safety factor SF1 of the hybrid tube, and setting a material, a modulus of elasticity E, and an inner diameter IDm of the metal tube; (b) calculating a slenderness ratio using values of a second outer diameter OD2 in a range equal to or less than the first outer diameter OD1, the inner diameter IDm, and the length L to determine a method for calculating a critical buckling load PC of the metal tube for each of the values of the second outer diameter OD2; (c) calculating the critical buckling load PC and a second safety factor SF2 of the metal tube for each of the values of the second outer diameter OD2 by the determined method, and calculating a third safety factor SF3 of the metal tube closest to the first safety factor SF1 among the respective calculated second safety factors SF2; and (d) deriving an optimal ratio between the metal tube and the composite material layer for weight reduction by using a second outer diameter OD2 corresponding to the third safety factor SF3 as an outer diameter ODm of the metal tube.

In addition, a hybrid tube according to the present disclosure may be manufactured by any one of the above methods.

As described above, according to the present disclosure, the following effects can be expected.

As it is possible to derive the optimal ratio between heterogeneous materials that can realize weight reduction while satisfying a target buckling load when manufacturing a hybrid tube, it is possible to contribute to reduction of the weight of tubes of metal materials and the weight of related apparatuses.

The above and other effects of the present disclosure will be encompassed widely in the scope of the present disclosure by not only the above-described embodiments and the descriptions in the appended claims, but also effects that can occur within the scope of the present disclosure that can be easily inferred therefrom and possibilities of potential advantages contributing to industrial development.

### BRIEF DESCRIPTION OF THE DRAWINGS

FIG. 1 is a view illustrating a hybrid tube according to the present disclosure.

FIG. 2 is a flow chart illustrating a manufacturing method for a hybrid tube according to the present disclosure.

FIG. 3 is a table illustrating a population for Example 1 of the present disclosure.

FIGS. 4 and 5 are tables illustrating data calculated by selecting 49 mm and 46 mm as values of a metal outer diameter ODm of the population of Example 1, and selecting values of a metal inner diameter IDm for each of the metal outer diameter values.

FIG. 6 is a table illustrating the results according to Example 1 of the present disclosure.

FIG. 7 is a table illustrating a population for Example 2 of the present disclosure.

FIGS. 8 to 12 are tables illustrating data calculated by selecting 61 mm, 58 mm, 55 mm, 52 mm, and 49 mm as values of a metal outer diameter ODm of the population of Example 2, and selecting values of a metal inner diameter IDm for each of the metal outer diameter values.

FIG. 13 is a table illustrating the results according to Example 2 of the present disclosure.

FIG. 14 is a table illustrating data calculated using set values according to Example 3 of the present disclosure.

FIG. 15 is a table illustrating data calculated using set values according to Example 4 of the present disclosure.

FIG. 16 is a table illustrating data calculated using set values according to Example 5 of the present disclosure.

FIG. 17 is a table illustrating data calculated using set values according to Example 6 of the present disclosure.

FIG. 18 is a table illustrating the results according to Examples 3 to 6 of the present disclosure.

FIG. 19 is an image of a hybrid round rod, a metal round rod, and a CFRP tube illustrating the state after a buckling test for reference.

FIG. 20 is a table illustrating the results of the buckling test performed on the hybrid round rod, the metal round rod, and the CFRP tube for reference.

FIG. 21 is a graph illustrating buckling result values of FIG. 20.

### DETAILED DESCRIPTION OF THE INVENTION

Hereinafter, exemplary embodiments of the present disclosure will be described in detail with reference to the accompanying drawings. Prior to the description, advantages and features of the present disclosure and methods of achieving the advantages and features will be clear with reference to embodiments described in detail below when taken in conjunction with the accompanying drawings. Terms used in this specification are for the purpose of describing the embodiments and thus should not be construed as limiting the present disclosure, and it is noted that the singular forms are intended to include the plural forms as well, unless the context clearly indicates otherwise. Further, in the description, a term indicating the direction is for aiding understanding of the description and can be changed according to the viewpoint.

The present disclosure is to provide a manufacturing method for a hybrid tube, the method including the step of deriving an optimal ratio between a metal tube and a composite material layer when manufacturing the hybrid tube in which the composite material layer is formed on an outer circumferential surface of the metal tube in order to reduce the weight of an existing metal tube such as a cylinder tube of a hydraulic cylinder.

In deriving the optimal ratio between the metal tube and the composite material layer according to the present disclosure, it is noted that the physical properties of the composite material layer and the numerical values for strength against buckling are presented for reference only as data obtained from the results of a buckling test performed on a hybrid rod composed of a metal round rod and a composite material layer. It is also noted that the units of weight and length are Kg and mm unless otherwise specified.

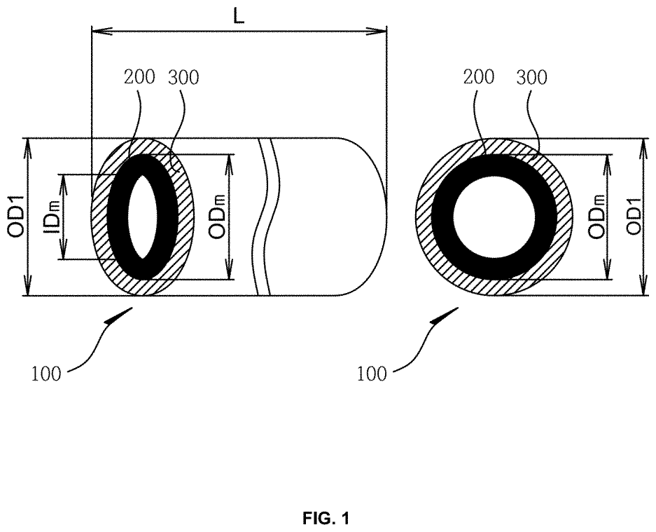

As illustrated in FIG. 1, the hybrid tube 100 according to the present disclosure includes the metal tube 200 and the composite material layer 300 formed on the outer circumferential surface of the metal tube 200, and a thickness OD1-IDm of the hybrid tube 100 includes a thickness ODm-IDm of the metal tube 200 and a thickness OD1-ODm of the composite material layer 300.

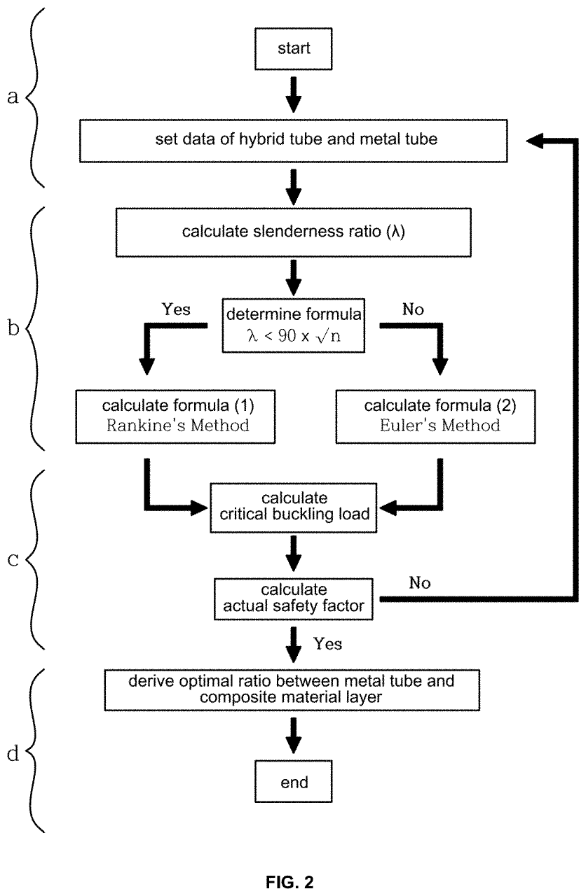

Referring to FIG. 2 in conjunction with the above-described drawing, the method including the step of deriving the optimal ratio between the metal tube 200 and the composite material layer 300 of the hybrid tube 100 includes steps (a), (b), (c), and (d).

First, the step (a) is performed, in which a first outer diameter OD1, which is a set outer diameter, a length L, a set buckling load F, an end condition factor n, and a first safety factor SF1, which is a set safety factor, of the hybrid tube 100 are set, and physical properties such as material, modulus of elasticity E, and density of the metal tube 200 are set.

In the step (a), data for deriving the optimal ratio of the composite material layer 300 is calculated by setting a target dimension of each of the hybrid tube 100 and the metal tube 200.

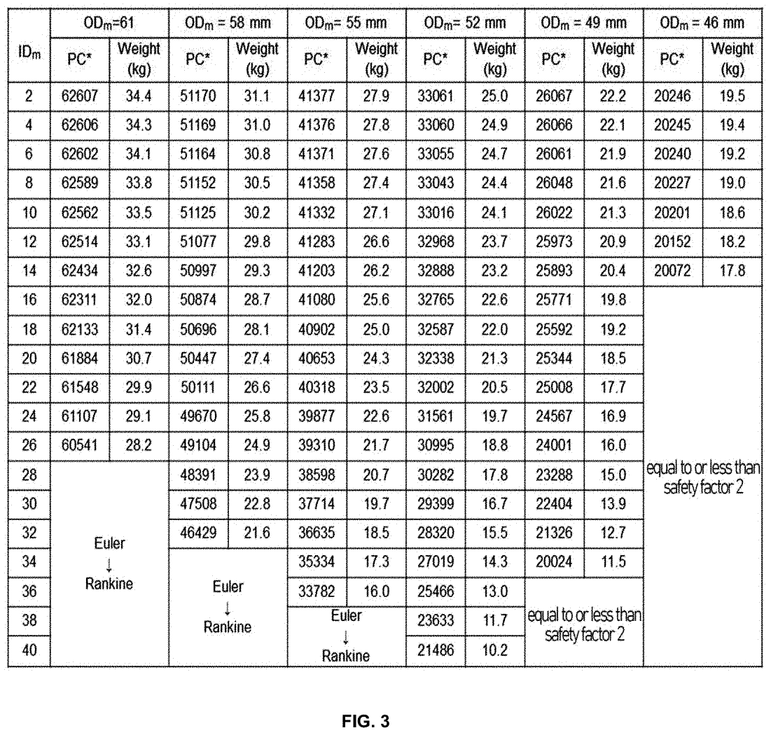

Next, as illustrated in FIG. 3, the step (b) is performed, in which a population for a thickness value of the metal tube 200 is selected in the range equal to or less than the first outer diameter OD1, and a slenderness ratio λ is calculated using the selected population and the length L to determine a method for calculating a critical buckling load PC of the population.

The population for the thickness value of the metal tube 200 is formed by selecting any one of values of a second outer diameter OD2 in the range equal to or less than the first outer diameter OD1 as a value of a metal outer diameter ODm, selecting values within the range equal to or less than the selected value of the metal outer diameter ODm as values of a metal inner diameter IDm, selecting a plurality of values of the metal outer diameter ODm, and selecting values of the metal inner diameter IDm for each of the selected plurality of values of the metal outer diameter ODm.

Here, the second outer diameter OD2 includes values in the range equal to or less than the first outer diameter OD1, and when the first outer diameter OD1 is 70 mm, may include all length values of equal to or less than 70 mm. In addition, the metal outer diameter ODm is selected from among all length values equal to or less than the second outer diameter OD2 of 70 mm. For example, when 61 mm, 58 mm, 55 mm, 52 mm, 49 mm, and 46 mm are selected, these are values of the metal outer diameter ODm. In addition, the metal inner diameter IDm includes values in the range equal to or less than the metal outer diameter ODm. For example, in the case of 61 mm among the selected values of the metal outer diameter ODm, the metal inner diameter IDm may include all length values equal to or less than 61 mm, and in the case of 46 mm, the metal inner diameter IDm may include all length values equal to or less than 46 mm.

In the step (b), the slenderness ratio λ is calculated by Formula 1 below using the length L, the values of the metal outer diameter ODm, and the values of the metal inner diameter IDm, and the method for calculating the critical buckling load PC of the metal tube 200 according to each of the respective calculated values of the slenderness ratio λ is determined.

In other words, when each of the calculated values of the slenderness ratio λ falls within the range of Formula 2, the critical buckling load PC of the metal tube 200 is calculated using Rankine's method as in Formula 4, and when each of the values of the slenderness ratio λ falls within the range of Formula 3, the critical buckling load PC of the metal tube 200 is calculated using Euler's method as in Formula 5.

$$\begin{matrix}λ = \frac{L}{k} = \frac{4 \times L}{\sqrt{{ODm}^{2} + {ID}^{2}}} & [ Formula 1 ] \\ λ < 90 \times \sqrt{n} & [ Formula 2 ] \\ λ \geq 90 \times \sqrt{n} & [ Formula 3 ] \\ PC = \frac{{σ}_{c} \times Ar}{1 + \frac{a}{N} \times {( \frac{L}{K} )}^{2}} & [ Formula 4 ] \\ PC = \frac{n \times {}^{2} \times E \times I}{{L}^{2}} & [ Formula 5 ]\end{matrix}$$

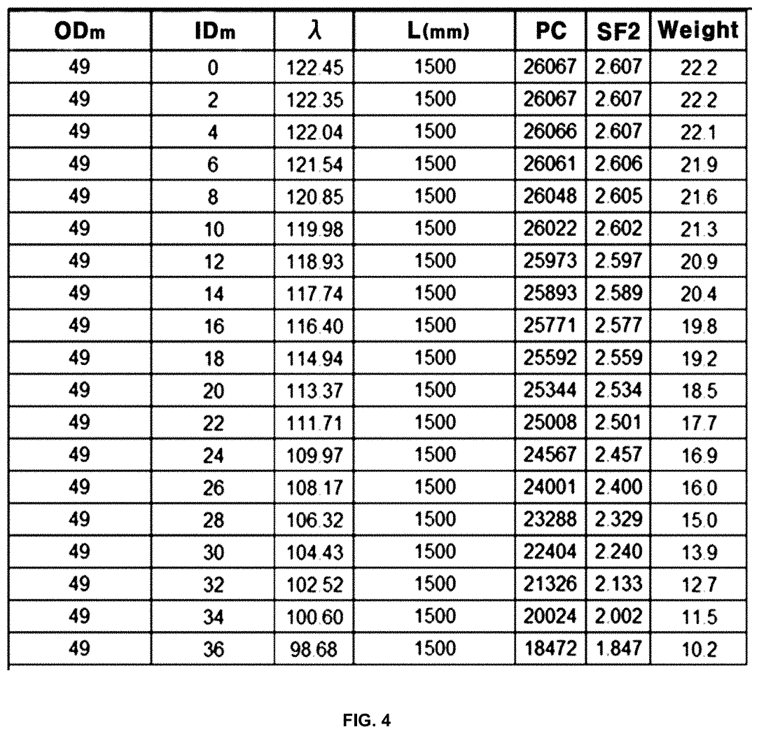

Subsequently, as illustrated in FIGS. 4 and 5, the step (c) is performed, in which the critical buckling load PC, and a second safety factor SF2 of the metal tube 200 are calculated using the determined method for calculating the critical buckling load PC and each of the values of the metal outer diameter ODm and values of the metal inner diameter IDm selected from the population, and a third safety factor SF3 of the metal tube 200 closest to the first safety factor SF1 among the calculated respective second safety factors SF2 is calculated.

Here, each of the second safety factors SF2 is a value calculated for the length L and each of the values of the metal outer diameter ODm and values of the metal inner diameter IDm selected from the population, and the third safety factor SF2 is a value closest to the first safety factor SF1 among the calculated second safety factors SF2.

Here, if the calculated value of the slenderness ratio λ falls within the range to which the Euler's method should be applied and thus the critical buckling load PC is calculated using Euler's method, the value of the slenderness ratio λ may fall within the range to which Rankine's method should be applied in the course of gradually decreasing the values of the metal inner diameter IDm. In this case, a value of the critical buckling load PC calculated using Euler's method and a value of the critical buckling load PC calculated using Rankine's method cannot be organically linked because these values are for hybrid tubes of different structures under the structural boundary conditions of the hybrid tubes.

Therefore, if the critical buckling load PC is calculated using Euler's method and is calculated using Rankine's method as the values of the metal inner diameter IDm are decreased, the critical buckling load PC calculated using Rankine's method should be interpreted separately from the critical buckling load PC calculated using Euler's method.

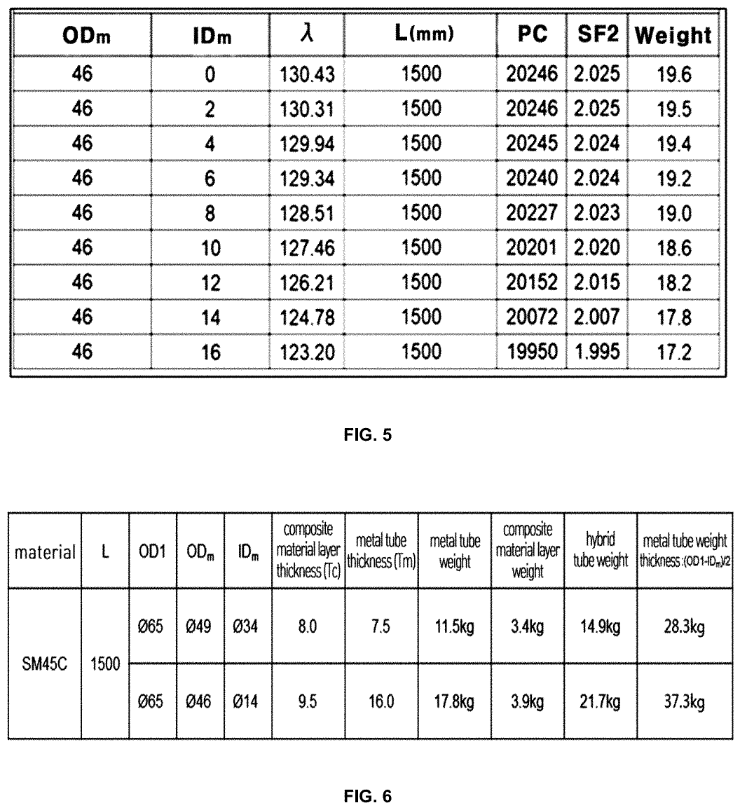

Finally, as illustrated in FIG. 6, the step (d) is performed, in which the optimal ratio between the metal tube 200 and the composite material layer 300 is derived by using a thickness that can reduce the weight of the hybrid tube 100 among thickness values of the metal tube 200 [values of the metal outer diameter ODm and values of the metal inner diameter IDm] selected from the population, the thickness values corresponding to the third safety factor SF3.

In the step (d), as described above, since the present disclosure is for calculating the optimal ratio between the metal tube 200 and the composite material layer 300 for weight reduction without taking into account the physical properties of the composite material layer 300 and its strength against buckling, a thickness Tm of the metal tube 200 that satisfies the first safety factor SF1 can be derived by using values of the metal outer diameter ODm and metal inner diameter IDm corresponding to the third safety factor SF3.

Therefore, a thickness Tc of the composite material layer 300 is calculated by Formula 6 below using the thickness Tm of the metal tube 200 that satisfies the first safety factor SF1, and the optimal ratio of the composite material layer 300 to the hybrid tube 100 is calculated by Equation 7 below using the calculated thickness Tc of the composite material layer 300.

$$\begin{matrix}Tc = \frac{OD 1 - ODm}{2} & [ Formula 6 ] \\ Ratio = \frac{2 Tc}{OD 1 - IDm} & [ Formula 7 ]\end{matrix}$$

Hereinafter, exemplary embodiments of a manufacturing method for a hybrid tube will be described to help the understanding of the present disclosure.

### EXAMPLE 1

In Example 1, setting conditions for a hybrid tube 100 were as follows: length L: 1500 mm, outer diameter OD1: 65 mm, set applied load F: 10,000 kgf, end condition factor n: 1 (pinned-pinned), and set safety factor SF1: 2.

In addition, setting conditions for a metal tube 200 were as follows: material: SM45C, modulus of elasticity E: 21,000 kgf/mm², and density: 7.85 kgf/mm².

As illustrated in FIGS. 3 to 5, in Example 1, under the above setting conditions, 61 mm, 58 mm, 55 mm, 52 mm, 49 mm, and 46 mm were selected as values of a metal outer diameter ODm, and an even number equal to or less than 40 mm was selected as a value of a metal inner diameter IDm for each of the values of the metal outer diameter ODm.

As a result of calculating a slenderness ratio λ using each of the selected values of the metal outer diameter ODm and the respective selected values of the metal inner diameter IDm and then calculating a critical buckling load PC and a second safety factor SF2 using Euler's method, it could be found that when the metal outer diameter ODm was 49 mm, the second safety factor SF2 for the metal inner diameter IDm of 34 mm was 2.002, which was the closest to the first safety factor SF1, and when the metal outer diameter ODm was 46 mm, the second safety factor SF2 for the metal inner diameter IDm of 14 mm was 2.007, which was the closest to the first safety factor SF1.

Referring to FIG. 6 in conjunction with the above, when the outer diameter of the metal tube 200 was 49 mm, since the second safety factor SF2 was the closest to the first safety factor SF1, which was the set safety factor, when the inner diameter of the metal tube 200 was 34 mm, a thickness Tm of the metal tube 200 was 7.5 mm, a thickness Tc of a composite material layer 300 was 8 mm, and the ratio of the composite material layer 300 in the hybrid tube 100 was 51.61% (0.5161). In addition, the weight of the metal tube 200 was calculated as 11.5 kg, the weight of the composite material layer 300 was calculated as 3.4 kg assuming that the composite material was CFRP, and the weight of the hybrid tube 100 was calculated as 14.9 kg. Here, the weight of a metal tube having an outer diameter of 65 mm and an inner diameter of 34 mm, rather than a hybrid tube, was calculated as 28.3 kg, and thus weight could be reduced by 13.4 kg when manufacturing the hybrid tube 100 according to the present disclosure.

In addition, when the outer diameter of the metal tube 200 was 46 mm, since the second safety factor SF2 was the closest to the first safety factor SF1, which was the set safety factor, when the inner diameter of the metal tube 200 was 14 mm, the thickness Tm of the metal tube 200 was 16 mm, the thickness Tc of the composite material layer 300 was 9.5 mm, and the ratio of the composite material layer in the hybrid tube 100 was 37.25% (0.3725). In addition, the weight of the metal tube 200 was calculated as 17.8 kg, the weight of the composite material layer 300 was calculated as 3.9 kg assuming that the composite material was CFRP, and the weight of the hybrid tube 100 was calculated as 21.7 kg. Here, the weight of a metal tube having an outer diameter of 65 mm and an inner diameter of 14 mm, rather than a hybrid tube, was calculated as 37.3 kg, and thus weight could be reduced by 15.6 kg when manufacturing the hybrid tube 100 according to the present disclosure.

In summary, if the criterion for weight reduction of the hybrid tube 100 according to Example 1 was to reduce the total weight, when the outer diameter of the metal tube 200 was 46 mm and the inner diameter thereof was 14 mm, an optimal ratio between the composite material layer 300 and the metal tube 200 could be derived. On the other hand, if the criterion for weight reduction was the ratio of the hybrid tube 100, when the outer diameter of the metal tube 200 was 49 mm and the inner diameter thereof was 34 mm, the optimal ratio of the composite material layer 300 and the metal tube 200 could be derived. Thus, it could be found that the thickness of the composite material layer 300 and the metal tube 200 may vary in the hybrid tube 100 according to the criteria for weight reduction.

### EXAMPLE 2

In Example 2, setting conditions for a hybrid tube 100 were as follows: length L: 700 mm, outer diameter OD1: 65 mm, set applied load F: 10,000 kgf, end condition factor n: 1 (pinned-pinned), and set safety factor SF1: 2.

In addition, setting conditions for a metal tube 200 were as follows: material: SM45C, modulus of elasticity E: 21,000 kgf/mm², and density: 7.85 kgf/mm².

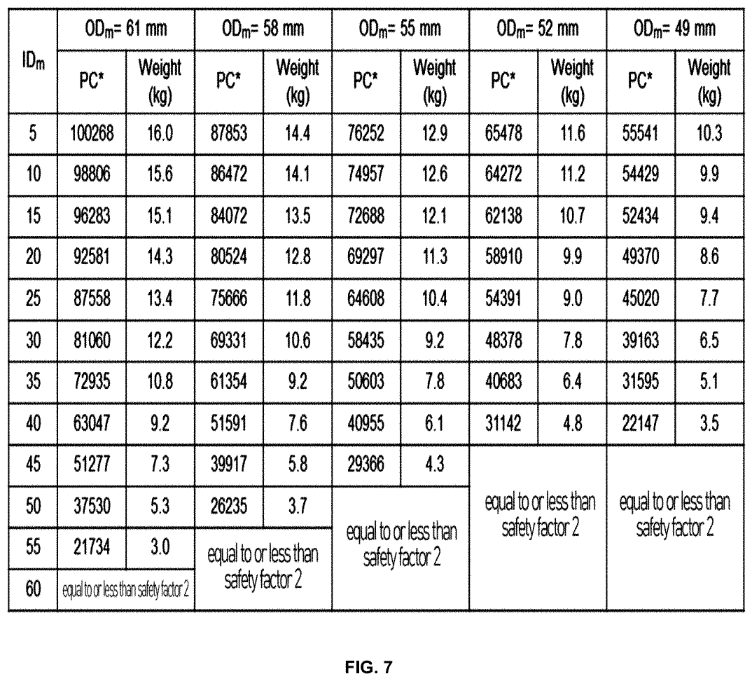

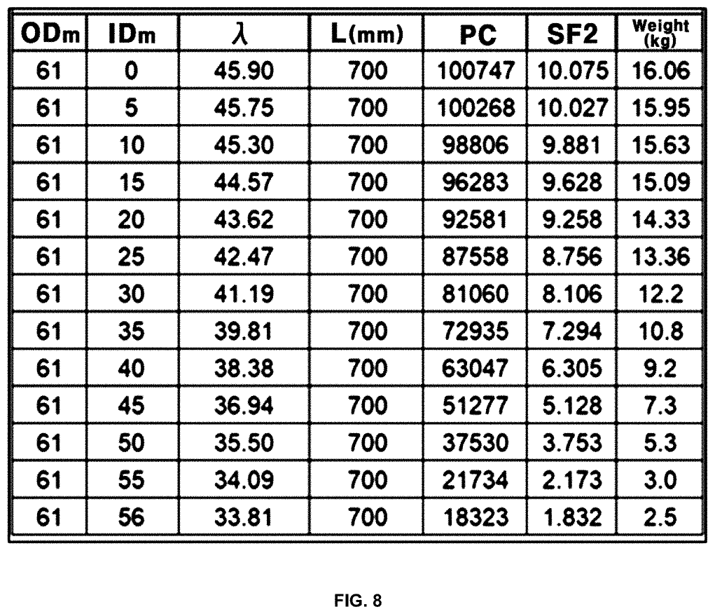

As illustrated in FIGS. 7 to 12, in Example 2, under the above setting conditions, 61 mm, 58 mm, 55 mm, 52 mm, and 49 mm were selected as values of a metal outer diameter ODm, and a multiple of 5 equal to or less than 60 mm was selected as a value of a metal inner diameter IDm for each of the values of the metal outer diameter ODm.

As a result of calculating a slenderness ratio λ using each of the selected values of the metal outer diameter ODm and the selected values of the metal inner diameter IDm and then calculating a critical buckling load PC and a second safety factor SF 2 using Rankine's method (compressive strength σc: 49 kgf/mm² and experimental constant a: 0.0002 in Rankine's method), when the metal outer diameter ODm was 61 mm, the second safety factor SF2 for the metal inner diameter IDm of 55 mm was 2.173, which was the closest to the first safety factor SF1.

In addition, when the metal outer diameter ODm was 58 mm, the second safety factor SF2 for the metal inner diameter IDm of 52 mm was 2.018, which was the closest to the first safety factor SF1.

In addition, when the metal outer diameter ODm was 55 mm, the second safety factor SF2 for the metal inner diameter IDm of 48 mm was 2.144, which was the closest to the first safety factor SF1.

In addition, when the metal outer diameter ODm was 52 mm, the second safety factor SF2 for the metal inner diameter IDm of 44 mm was 2.209, which was the closest to the first safety factor SF1.

In addition, when the metal outer diameter ODm was 49 mm, the second safety factor SF2 for the metal inner diameter IDm of 41 mm was 2.002, which was the closest to the first safety factor SF1.

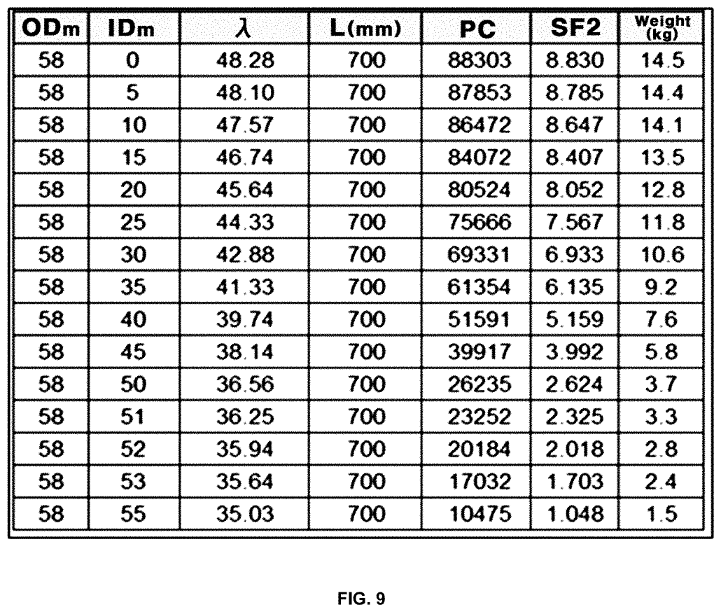

Referring to FIG. 13 in conjunction with the above, when the outer diameter of the metal tube 200 was 61 mm, since the second safety factor SF2 was the closest to the first safety factor SF1, which was the set safety factor, when the inner diameter of the metal tube 200 was 55 mm, a thickness Tm of the metal tube 200 was 3.0 mm, a thickness Tc of a composite material layer 300 was 2.0 mm, and the ratio of the composite material layer 300 in the hybrid tube 100 was 40.00% (0.4000). In addition, the weight of the metal tube 200 was calculated as 3.0 kg, the weight of the composite material layer 300 was calculated as 0.4 kg assuming that the composite material was CFRP, and the weight of the hybrid tube 100 was calculated as 3.4 kg. Here, the weight of a metal tube having an outer diameter of 65 mm and an inner diameter of 55 mm, rather than a hybrid tube, was calculated as 5.2 kg, and thus weight could be reduced by 1.8 kg when manufacturing the hybrid tube 100 according to the present disclosure.

In addition, when the outer diameter of the metal tube 200 was 58 mm, since the second safety factor SF2 was the closest to the first safety factor SF1, which was the set safety factor, when the inner diameter of the metal tube 200 was 52 mm, the thickness Tm of the metal tube 200 was 3.0 mm, the thickness Tc of the composite material layer 300 was 3.5 mm, and the ratio of the composite material layer 300 in the hybrid tube 100 was 53.85% (0.5385). In addition, the weight of the metal tube 200 was calculated as 2.8 kg, the weight of the composite material layer 300 was calculated as 0.8 kg assuming that the composite material was CFRP, and the weight of the hybrid tube 100 was calculated as 3.6 kg. Here, the weight of a metal tube having an outer diameter of 65 mm and an inner diameter of 52 mm, rather than a hybrid tube, was calculated as 6.6 kg, and thus weight could be reduced by 3.0 kg when manufacturing the hybrid tube 100 according to the present disclosure.

In addition, when the outer diameter of the metal tube 200 was 55 mm, since the second safety factor SF2 was the closest to the first safety factor SF1, which was the set safety factor, when the inner diameter of the metal tube 200 was 48 mm, the thickness Tm of the metal tube 200 was 3.5 mm, the thickness Tc of the composite material layer 300 was 5.0 mm, and the ratio of the composite material layer 300 in the hybrid tube 100 was 58.82% (0.5882). In addition, the weight of the metal tube 200 was calculated as 3.1 kg, the weight of the composite material layer 300 was calculated as 1.1 kg assuming that the composite material was CFRP, and the weight of the hybrid tube 100 was calculated as 4.2 kg. Here, the weight of a metal tube having an outer diameter of 65 mm and an inner diameter of 48 mm, rather than a hybrid tube, was calculated as 8.3 kg, and thus weight could be reduced by 4.1 kg when manufacturing the hybrid tube 100 according to the present disclosure.

In addition, when the outer diameter of the metal tube 200 was 52 mm, since the second safety factor SF2 was the closest to the first safety factor SF1, which was the set safety factor, when the inner diameter of the metal tube 200 was 44 mm, the thickness Tm of the metal tube 200 was 4.0 mm, the thickness Tc of the composite material layer 300 was 6.5 mm, and the ratio of the composite material layer 300 in the hybrid tube 100 was 61.90% (0.6190). In addition, the weight of the metal tube 200 was calculated as 3.3 kg, the weight of the composite material layer 300 was calculated as 1.3 kg assuming that the composite material was CFRP, and the weight of the hybrid tube 100 was calculated as 4.6 kg. Here, the weight of a metal tube having an outer diameter of 65 mm and an inner diameter of 44 mm, rather than a hybrid tube, was calculated as 9.9 kg, and thus weight could be reduced by 5.3 kg when manufacturing the hybrid tube 100 according to the present disclosure.

In addition, when the outer diameter of the metal tube 200 was 49 mm, since the second safety factor SF2 was the closest to the first safety factor SF1, which was the set safety factor, when the inner diameter of the metal tube 200 was 41 mm, the thickness Tm of the metal tube 200 was 4.0 mm, the thickness Tc of the composite material layer 300 was 8.0 mm, and the ratio of the composite material layer 300 in the hybrid tube 100 was 66.67% (0.6667). In addition, the weight of the metal tube 200 was calculated as 3.1 kg, the weight of the composite material layer 300 was calculated as 1.6 kg assuming that the composite material was CFRP, and the weight of the hybrid tube 100 was calculated as 4.7 kg. Here, the weight of a metal tube having an outer diameter of 65 mm and an inner diameter of 41 mm, rather than a hybrid tube, was calculated as 11.0 kg, and thus weight could be reduced by 6.3 kg when manufacturing the hybrid tube 100 according to the present disclosure.

In summary, if the criterion for weight reduction of the hybrid tube 100 according to Example 2 was to reduce the total weight, when the outer diameter of the metal tube 200 was 49 mm and the inner diameter thereof was 41 mm, an optimal ratio between the composite material layer 300 and the metal tube 200 could be derived. In addition, even if the criterion for weight reduction was the ratio of the hybrid tube 100, when the outer diameter of the metal tube 200 was 49 mm and the inner diameter thereof was 41 mm, the optimal ratio of the composite material layer 300 and the metal tube 200 could be derived.

Meanwhile, in Examples 1 and 2 described above, the thickness of the metal tube and the thickness of the composite material layer were calculated by setting the inner and outer diameters of the metal tube as variables. Hereinafter, by setting the inner diameter of the metal tube in advance, the thickness of the metal tube and the thickness of the composite material layer will be calculated with only the outer diameter of the metal tube as a variable to derive optimal ratio therebetween.

As illustrated in FIG. 1, a hybrid tube 100 according to the present disclosure includes a metal tube 200 and a composite material layer 300 formed on an outer circumferential surface of the metal tube 200, and a thickness OD1-IDm of the hybrid tube 100 includes a thickness ODm-IDm of the metal tube 200 and a thickness OD1-ODm of the composite material layer 300.

Referring to FIG. 2 in conjunction with the above-described drawing, in a method including the step of deriving an optimal ratio between the metal tube 200 and the composite material layer 300 of the hybrid tube 100, a step (a) is performed, in which a first outer diameter OD1, which is a set outer diameter, a length L, a set buckling load F, an end condition factor n, and a first safety factor SF1, which is a set safety factor, of the hybrid tube 100 are set, and physical properties such as inner diameter IDm, material, modulus of elasticity E, and density of the metal tube 200 are set.

In the step (a), data for deriving the optimal ratio of the composite material layer 300 is calculated by setting a target dimension of each of the hybrid tube 100 and the metal tube 200.

Next, a step (b) is performed, in which a method for calculating a critical buckling load PC of the metal tube 200 is determined by calculating a slenderness ratio λ using the length L and values of a second outer diameter OD2 in the range equal to or less than the first outer diameter OD1. Here, the second outer diameter OD2 includes values in the range equal to or less than the first outer diameter OD1, and when the first outer diameter OD1 is 65 mm, may include all length values of equal to or less than 65 mm.

In the step (b), the slenderness ratio λ is calculated by Formula 1 below using the length L, and the values of the second outer diameter OD2, and the method for calculating the critical buckling load PC of the metal tube 200 according to each of the respective calculated values of the slenderness ratio λ is determined.

When each of the calculated values of the slenderness ratio λ falls within the range of Formula 2, the critical buckling load PC of the metal tube 200 is calculated using Rankine's method as in Formula 4, and when each of the values of the slenderness ratio λ falls within the range of Formula 3, the critical buckling load PC of the metal tube 200 is calculated using Euler's method as in Formula 5.

Subsequently, a step (c) is performed, in which the critical buckling load PC, and a second safety factor SF2 of the metal tube 200 are calculated using the determined method for calculating the critical buckling load PC and each of the values of the second outer diameter OD2, and a third safety factor SF3 of the metal tube 200 closest to the first safety factor SF1 among the calculated respective second safety factors SF2 is calculated. Here, each of the second safety factors SF2 is a value calculated for the length L and each of the values of the second outer diameter OD2, and the third safety factor SF2 is a value closest to the first safety factor SF1 among the calculated second safety factors SF2.

Here, if the calculated value of the slenderness ratio λ falls within the range to which the Euler's method should be applied and thus the critical buckling load PC is calculated using Euler's method, the value of the slenderness ratio λ may fall within the range to which Rankine's method should be applied in the course of gradually decreasing the values of the second outer diameter OD2. In this case, a value of the critical buckling load PC calculated using Euler's method and a value of the critical buckling load PC calculated using Rankine's method cannot be organically linked because these values are for hybrid tubes of different structures under the structural boundary conditions of the hybrid tubes.

Therefore, if the critical buckling load PC is calculated using Euler's method and is calculated using Rankine's method as the values of the second outer diameter OD2 are decreased, the critical buckling load PC calculated using Rankine's method should be interpreted separately from the critical buckling load PC calculated using Euler's method.

Finally, a step (d) is performed, in which the optimal ratio between the metal tube 200 and the composite material layer 300 for weight reduction is derived by using a second outer diameter OD2 corresponding to the third safety factor SF3 as an outer diameter ODm of the metal tube 200.

In the step (d), as described above, since the present disclosure is for calculating the optimal ratio between the metal tube 200 and the composite material layer 300 for weight reduction without taking into account the physical properties of the composite material layer 300 and its strength against buckling, the second outer diameter OD2 corresponding to the third safety factor SF3 is the outer diameter ODm of the metal tube 200 that satisfies the first safety factor SF1.

Therefore, a thickness Tc of the composite material layer 300 is calculated by Formula 6 below using the outer diameter ODm of the metal tube 200, and the optimal ratio of the composite material layer 300 to the hybrid tube 100 is calculated by Equation 7 below using the calculated thickness Tc of the composite material layer 300.

Hereinafter, exemplary embodiments of a manufacturing method for a hybrid tube will be described to help the understanding of present disclosure.

### EXAMPLE 3

In Example 3, setting conditions for a hybrid tube 100 were as follows: length L: 1500 mm, outer diameter OD1: 65 mm, set applied load F: 10,000 kgf, end condition factor n: 1 (pinned-pinned), and set safety factor SF1: 2.

In addition, setting conditions for a metal tube 200 were as follows: inner diameter IDm: 10 mm, material: SM45C, modulus of elasticity E: 21,000 kgf/mm², and density: 7.85 kgf/mm².

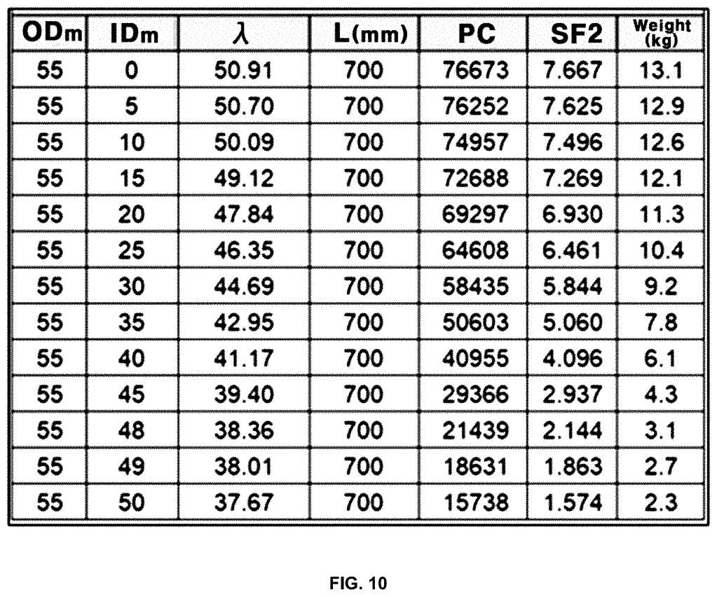

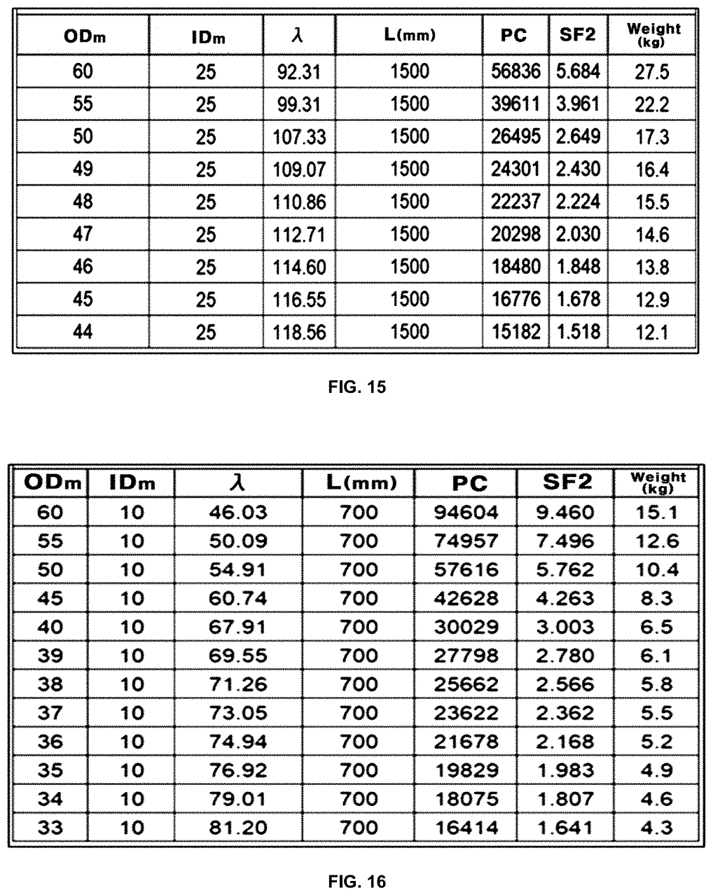

As illustrated in FIGS. 14 and 18, as a result of calculating respective slenderness ratios A with values of a second outer diameter OD2 and then calculating critical buckling loads PC and second safety factors SF2 of the metal tube 200 by Euler's method, a second safety factor SF2, which was the closest to the first safety factor SF1 among the second safety factors SF2, was 2.020, and this value of 2.020 was a third safety factor SF3. In addition, an outer diameter ODm of the metal tube 200 corresponding to the third safety factor SF3 was 46 mm. Thus, an optimal thickness Tc of a composite material layer 300 was 9.5 mm, and the ratio of the composite material layer 300 in the hybrid tube 100 was 34.55% (0.3455).

In addition, the weight of the metal tube 200 was calculated as 18.6 kg, the weight of the composite material layer 300 was calculated as 4.0 kg assuming that the composite material was CFRP, and the weight of the hybrid tube 100 was calculated as 22.6 kg. Here, the weight of a metal tube having an outer diameter of 65 mm and an inner diameter of 10 mm, rather than a hybrid tube, was calculated as 38.1 kg, and thus weight could be reduced by 15.5 kg when manufacturing the hybrid tube 100 according to the present disclosure.

### EXAMPLE 4

In Example 4, setting conditions for a hybrid tube 100 were as follows: length L: 1500 mm, outer diameter OD1: 65 mm, set applied load F: 10,000 kgf, end condition factor n: 1 (pinned-pinned), and set safety factor SF1: 2.

In addition, setting conditions for a metal tube 200 were as follows: inner diameter IDm: 25 mm, material: SM45C, modulus of elasticity E: 21,000 kgf/mm², and density: 7.85 kgf/mm².

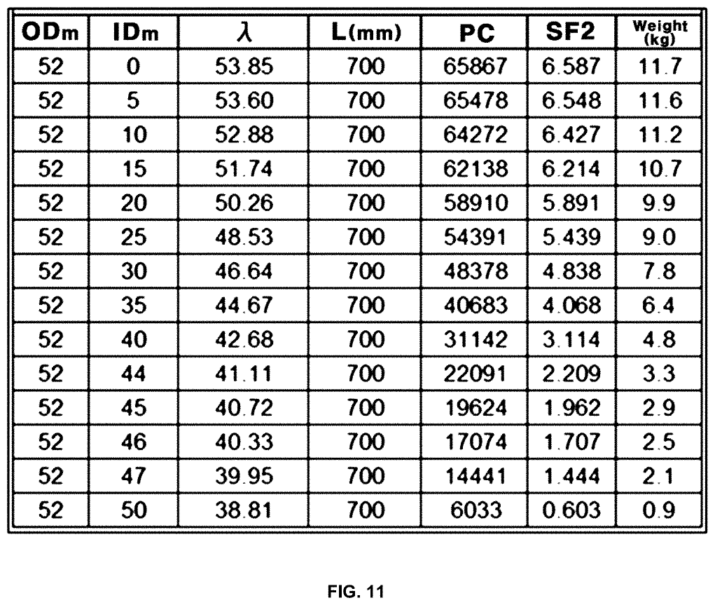

As illustrated in FIGS. 15 and 18, as a result of calculating respective slenderness ratios A with values of a second outer diameter OD2 and then calculating critical buckling loads PC and second safety factors SF2 of the metal tube 200 by Euler's method, a second safety factor SF2, which was the closest to the first safety factor SF1 among the second safety factors SF2, was 2.030, and this value of 2.030 was a third safety factor SF3. In addition, an outer diameter ODm of the metal tube 200 corresponding to the third safety factor SF3 was 47 mm. Thus, an optimal thickness Tc of a composite material layer 300 was 9.0 mm, and the ratio of the composite material layer 300 in the hybrid tube 100 was 45.00% (0.4500).

In addition, the weight of the metal tube 200 was calculated as 14.6 kg, the weight of the composite material layer 300 was calculated as 3.8 kg assuming that the composite material was CFRP, and the weight of the hybrid tube 100 was calculated as 18.4 kg. Here, the weight of a metal tube having an outer diameter of 65 mm and an inner diameter of 25 mm, rather than a hybrid tube, was calculated as 33.3 kg, and thus weight could be reduced by 14.9 kg when manufacturing the hybrid tube 100 according to the present disclosure.

As described above, if the criterion for weight reduction of the hybrid tube 100 according to each of Examples 3 and 4 was to reduce the total weight, when the outer diameter of the metal tube 200 was 46 mm and the inner diameter thereof was 10 mm, an optimal ratio between the composite material layer 300 and the metal tube 200 could be derived. On the other hand, if the criterion for weight reduction was the ratio of the hybrid tube 100, when the outer diameter of the metal tube 200 of Example 4 was 47 mm and the inner diameter thereof was 25 mm, the optimal ratio of the composite material layer 300 and the metal tube 200 could be derived.

### EXAMPLE 5

In Example 5, setting conditions for a hybrid tube 100 were as follows: length L: 700 mm, outer diameter OD1: 65 mm, set applied load F: 10,000 kgf, end condition factor n: 1 (pinned-pinned), and set safety factor SF1: 2.

In addition, setting conditions for a metal tube 200 were as follows: inner diameter IDm: 10 mm, material: SM45C, modulus of elasticity E: 21,000 kgf/mm², and density: 7.85 kgf/mm².

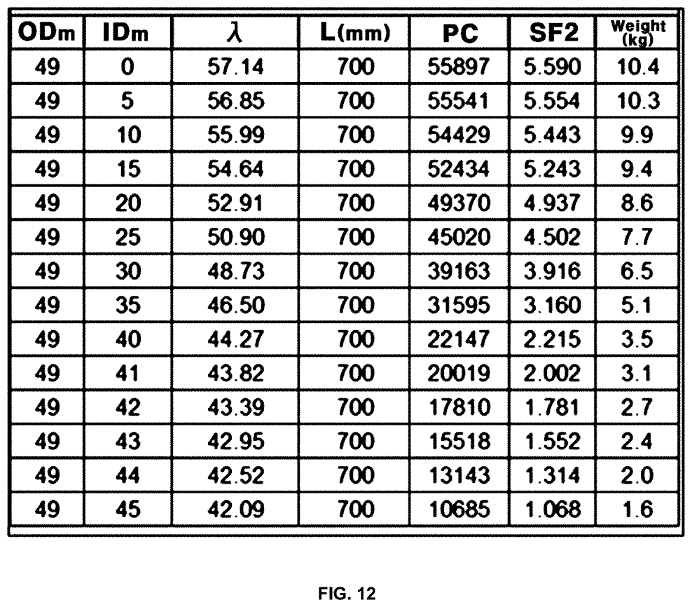

As illustrated in FIGS. 16 and 18, as a result of calculating respective slenderness ratios λ with values of a second outer diameter OD2 and then calculating critical buckling loads PC and second safety factors SF2 of the metal tube 200 using Rankine's method (compressive strength σc: 49 kgf/mm² and experimental constant a: 0.0002 in Rankine's method), a second safety factor SF2, which was the closest to the first safety factor SF1 among the second safety factors SF2, was 2.168, and this value of 2.168 was a third safety factor SF3. In addition, an outer diameter ODm of the metal tube 200 corresponding to the third safety factor SF3 was 36 mm. Thus, an optimal thickness Tc of a composite material layer 300 was 14.5 mm, and the ratio of the composite material layer 300 in the hybrid tube 100 was 52.73% (0.5273).

In addition, the weight of the metal tube 200 was calculated as 5.2 kg, the weight of the composite material layer 300 was calculated as 2.6 kg assuming that the composite material was CFRP, and the weight of the hybrid tube 100 was calculated as 7.8 kg. Here, the weight of a metal tube having an outer diameter of 65 mm and an inner diameter of 10 mm, rather than a hybrid tube, was calculated as 17.8 kg, and thus weight could be reduced by 10.0 kg when manufacturing the hybrid tube 100 according to the present disclosure.

### EXAMPLE 6

In Example 6, setting conditions for a hybrid tube 100 were as follows: length L: 700 mm, outer diameter OD1: 65 mm, set applied load F: 10,000 kgf, end condition factor n: 1 (pinned-pinned), and set safety factor SF1: 2.

In addition, setting conditions for a metal tube 200 were as follows: inner diameter IDm: 25 mm, material: SM45C, modulus of elasticity E: 21,000 kgf/mm², and density: 7.85 kgf/mm².

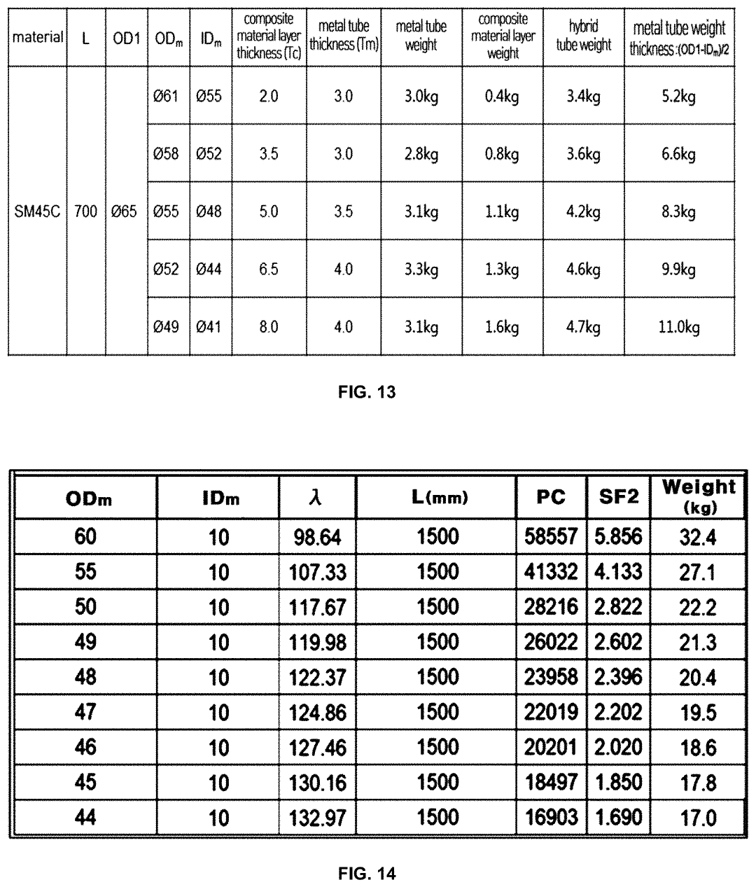

As illustrated in FIGS. 17 and 18, as a result of calculating respective slenderness ratios A with values of a second outer diameter OD2 and then calculating critical buckling loads PC and second safety factors SF2 of the metal tube 200 using Rankine's method (compressive strength σc: 49 kgf/mm² and experimental constant a: 0.0002 in Rankine's method), a second safety factor SF2, which was the closest to the first safety factor SF1 among the second safety factors SF2, was 2.201, and this value of 2.201 was a third safety factor SF3. In addition, an outer diameter ODm of the metal tube 200 corresponding to the third safety factor SF3 was 40 mm. Thus, an optimal thickness Tc of a composite material layer 300 was 12.5 mm, and the ratio of the composite material layer 300 in the hybrid tube 100 was 62.50% (0.6250).

In addition, the weight of the metal tube 200 was calculated as 4.2 kg, the weight of the composite material layer 300 was calculated as 2.3 kg assuming that the composite material was CFRP, and the weight of the hybrid tube 100 was calculated as 6.5 kg. Here, the weight of a metal tube having an outer diameter of 65 mm and an inner diameter of 25 mm, rather than a hybrid tube, was calculated as 15.5 kg, and thus weight could be reduced by 9 kg when manufacturing the hybrid tube 100 according to the present disclosure.

As described above, if the criterion for weight reduction of the hybrid tube 100 according to each of Examples 5 and 6 was to reduce the total weight, when the outer diameter of the metal tube 200 was 36 mm and the inner diameter thereof was 10 mm, an optimal ratio between the composite material layer 300 and the metal tube 200 could be derived. On the other hand, if the criterion for weight reduction was the ratio of the hybrid tube 100, when the outer diameter of the metal tube 200 of Example 6 was 40 mm and the inner diameter thereof was 25 mm, the optimal ratio of the composite material layer 300 and the metal tube 200 could be derived.

Next, in deriving the optimal ratio between the metal tube and the composite material layer according to the present disclosure, the physical properties of the composite material layer and the numerical values for strength against buckling are presented for reference only as data obtained from the results of a buckling test performed on a hybrid rod composed of a metal round rod and a composite material layer.

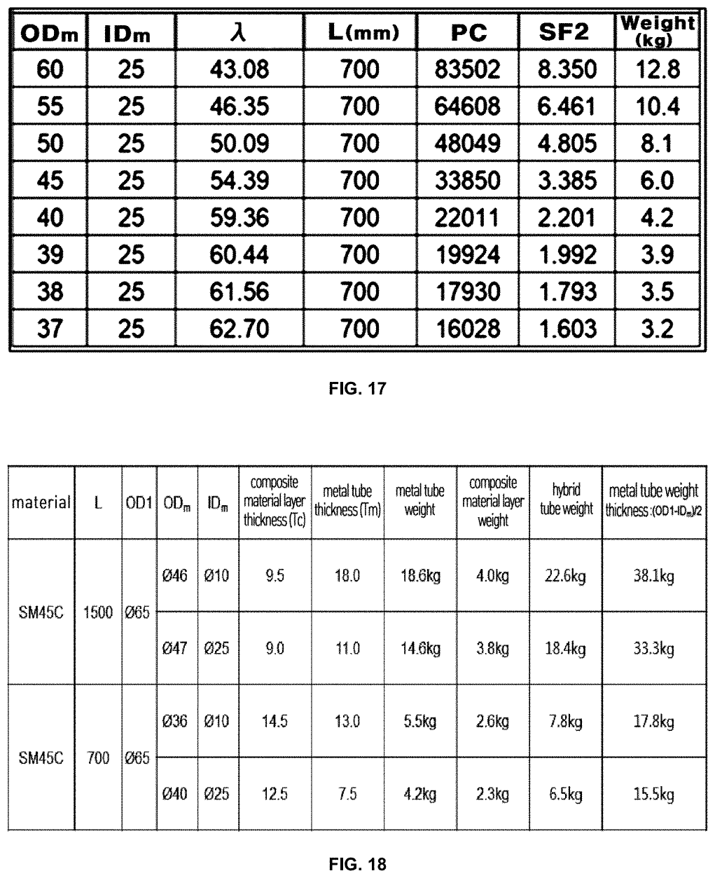

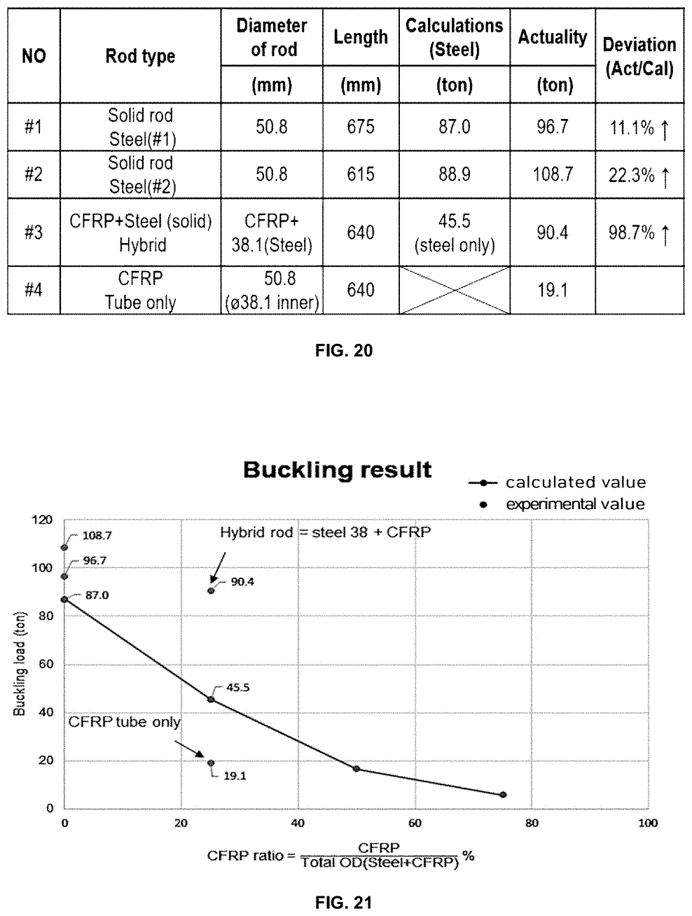

As illustrated in FIGS. 19 to 21, a hybrid round rod was applied to a rod of a hydraulic cylinder and undergone a buckling test together with rods of another metal material and a CFRP tube, and the results are as follows.

In this buckling test, buckling strength was measured through a compression test of each rod at Myongji University in Korea for 2 days from Jun. 21 to 22, 2018.

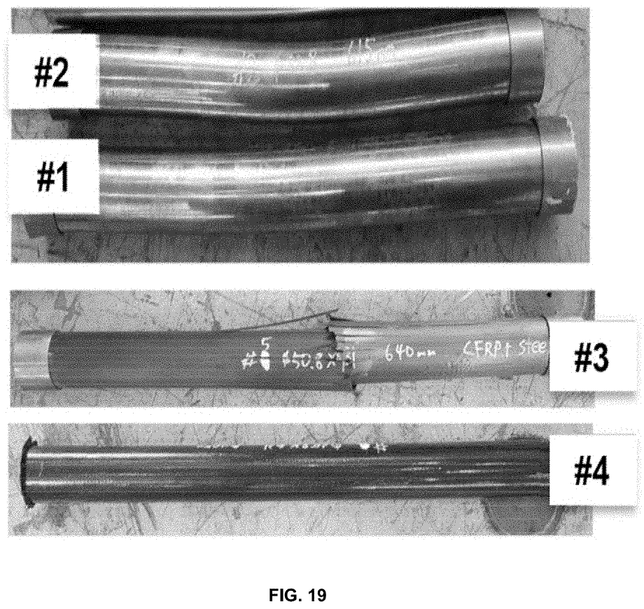

As illustrated in FIG. 20, as a result of the test, in the case of the hybrid round rod #3 according to the present disclosure, even though the ratio of metal was relatively reduced compared to a metal rod #1, an actual test value (#1: 96.7, #3: 90.4) similar to that of an existing material was exhibited due to a composite material layer. Thus, it was experimentally proved that the composite material layer contributed to weight reduction and provided sufficient strength to the hybrid round rod.

In addition, an actual value of the buckling strength of the hybrid round rod #3 was higher than the sum of an experimental value (19.1) of the CFRP tube #4 alone and a calculated value (45.5) of a metal round rod in the hybrid round rod #3. Thus, when manufacturing the hybrid round rod according to the present disclosure, it is expected that buckling strength equivalent to that of an existing metal round rod can be secured.

The above description of the exemplary embodiments is intended to be merely illustrative of the present disclosure, and those skilled in the art will appreciate that various modifications, additions, and substitutions are possible, without departing from the essential characteristics of the present disclosure. Further, the exemplary embodiments described herein and the accompanying drawings are for illustrative purposes and are not intended to limit the scope of the present disclosure, and the technical idea of the present disclosure is not limited by the exemplary embodiments and the accompanying drawings. The scope of protection sought by the present disclosure is defined by the appended claims and all equivalents thereof are construed to be within the true scope of the present disclosure.

The present disclosure relates to a hybrid tube and a manufacturing method therefor, and can find application in a hybrid tube formed by forming a plastic composite material layer on an outer circumferential surface of a metal tube in order to reduce the weight of an existing tube such as a cylinder tube.

1. A method of manufacturing a hybrid tube including a metal tube and a composite material layer formed on an outer circumferential surface of the metal tube for weight reduction, the method comprising the steps of:
(a) setting a first outer diameter (OD1), a length (L), a set buckling load (F), an end condition factor (n), and a first safety factor (SF1) of the hybrid tube, and setting a material and a modulus of elasticity (E) of the metal tube;
(b) selecting a population for a thickness value of the metal tube in a range equal to or less than the first outer diameter (OD1), and calculating a slenderness ratio using the selected population and the length (L) to determine a method for calculating a critical buckling load (PC) of the population;
(c) calculating the critical buckling load (PC) and a second safety factor (SF2) of the metal tube for the population by the determined method, and calculating a third safety factor (SF3) of the metal tube closest to the first safety factor (SF1) among the respective calculated second safety factors (SF2); and
(d) deriving an optimal ratio between the metal tube and the composite material layer for weight reduction by using a thickness that can reduce the weight of the hybrid tube among thickness values of the metal tube in the population, the thickness values corresponding to the third safety factor (SF3).

2. The method of claim 1, wherein the population for the thickness value of the metal tube is formed by selecting any one of values of a second outer diameter (OD2) in a range equal to or less than the first outer diameter (OD1) as a value of a metal outer diameter (ODm), selecting values within a range equal to or less than the selected value of the metal outer diameter (ODm) as values of a metal inner diameter (IDm), selecting a plurality of values of the metal outer diameter (ODm), and selecting values of the metal inner diameter (IDm) for each of the selected plurality of values of the metal outer diameter (ODm).

3. The method of claim 1, wherein the method for calculating the critical buckling load (PC) of the metal tube in the step (b) uses either Rankine's method or Euler's method according to the calculated slenderness ratio.

4. A method of manufacturing a hybrid tube including a metal tube and a composite material layer formed on an outer circumferential surface of the metal tube for weight reduction, the method comprising the steps of:
(a) setting a first outer diameter (OD1), a length (L), a set buckling load (F), an end condition factor (n), and a first safety factor (SF1) of the hybrid tube, and setting a material, a modulus of elasticity (E), and an inner diameter (IDm) of the metal tube;
(b) calculating a slenderness ratio using values of a second outer diameter (OD2) in a range equal to or less than the first outer diameter (OD1), the inner diameter (IDm), and the length (L) to determine a method for calculating a critical buckling load (PC) of the metal tube for each of the values of the second outer diameter (OD2);
(c) calculating the critical buckling load (PC) and a second safety factor (SF2) of the metal tube for each of the values of the second outer diameter (OD2) by the determined method, and calculating a third safety factor (SF3) of the metal tube closest to the first safety factor (SF1) among the respective calculated second safety factors (SF2); and
(d) deriving an optimal ratio between the metal tube and the composite material layer for weight reduction by using a second outer diameter (OD2) corresponding to the third safety factor (SF3) as an outer diameter (ODm) of the metal tube.

5. A hybrid tube manufactured by the method of claim 1.

6. A hybrid tube manufactured by the method of claim 4.
